(19) United States
(12) Patent Application Publication
(10) Pub. No.: US 2017/0235002 A1
(43) Pub. Date: Aug. 17, 2017

(54) Joint Interpolation and Deghosting of Seismic Data

(71) Applicant: WESTERNGECO LLC, Houston, TX (US)

(72) Inventors: Yousif Izzeldin Kamil Amin, Gatwick (GB); Massimiliano Vassallo, Gatwick (GB)

(21) Appl. No.: 15/518,474

(22) PCT Filed: Oct. 23, 2015
(86) PCT No.: PCT/US2015/057145

§ 371 Date: Apr. 11, 2017

Related U.S. Application Data
(60) Provisional application No. 62/068,114, filed on Oct. 24, 2014.

(51) Int. Cl. G01V 1/36; G01V 1/38

(52) U.S. Cl. CPC G01V 1/364; G01V 1/38; G01V 2210/56; G01V 2210/57

(57) ABSTRACT

Systems, methods, and computer-readable media for estimating a component of a seismic wavefield. The method may include accessing marine seismic data comprising a plurality of discrete measurements of a seismic wavefield; processing the marine seismic data to determine a relationship between a plurality of components of the seismic wavefield and each of the discrete measurements; and estimating from the marine seismic data processed via the one or more processors, each component of the seismic wavefield separated from each of the other plurality of components of the seismic wavefield and evaluated at a predetermined position.

### CROSS-REFERENCE TO RELATED APPLICATIONS

This application claims priority to U.S. Provisional Patent Application Ser. No. 62/068,114, which was filed on Oct. 24, 2014. The entirety of this provisional application is incorporated herein by reference.

### BACKGROUND

In recent years, various techniques have been proposed to achieve joint interpolation and deghosting using measurements from a multi-sensor receiver platform that measures the pressure wavefield as well as the particle motion vector associated with the wavefield. The particle motion measurements may relate to particle velocities, accelerations, or even to gradients of the pressure wavefield, as the equation of motion directly relates the pressure gradients to the particle acceleration. The measurements may include up to three components, aligned along up to three orthogonal axes. Any subset of one of more components of pressure and particle motion measurements may be a suitable input for joint interpolation and deghosting. Joint interpolation and deghosting techniques generally rely on the “ghost model,” that is to say on a model that describes the relationship between upgoing and downgoing wavefields as perceived by each of the measured signals (e.g., pressure and/or particle motion directional components). Such a model uses the knowledge of the depth of the sensors, and the model often implicitly assumes the sea surface is flat. However, generalizations of the model to rough sea scenarios have also been studied, although their realization is often impractical. When uncertainties are associated with the ghost model (e.g., due to problems in positioning the sensors, in measuring the position of the sensors, or to severe weather conditions), the joint interpolation and deghosting technique referenced above may fail to produce high quality results.

### SUMMARY

The above deficiencies and other problems associated with processing of collected data are reduced or eliminated by the disclosed methods and systems.

Embodiments of the present disclosure may provide for a method for joint interpolation and deghosting of seismic data. The method includes accessing marine seismic data including a plurality of discrete measurements of a seismic wavefield; processing, via the one or more processors, the marine seismic data to determine a relationship between a plurality of components of the seismic wavefield and each of the discrete measurements; and estimating, via the one or more processors, from the marine seismic data processed via the one or more processors, each component of the seismic wavefield separated from each of the other plurality of components of the seismic wavefield and evaluated at a predetermined position.

In some embodiments, the components of the seismic wavefield include an upgoing wavefield and a downgoing wavefield.

In some embodiments, the downgoing wavefield is a ghost reflection of the upgoing wavefield.

In some embodiments, the plurality of discrete measurements include at least one of pressure gradient, velocity, and acceleration of the seismic wavefield.

In some embodiments, the plurality of measurements includes particle motion measurements relating to a spatial gradient of pressure of the seismic wavefield.

In some embodiments, the discrete measurements are subjected to spatial aliasing in one or more spatial dimensions.

In some embodiments, processing the marine seismic data includes determining, via the one or more processors, a covariance matrix of the discrete measurements based on the estimated set of filter coefficients; estimating a set of filter coefficients to predict the plurality of components of the seismic wavefield from the seismic measurements; and determining, via the one or more processors, one of the plurality of components based on the covariance matrix of the marine seismic.

In some embodiments, processing the marine seismic data includes determining a model relating each of the plurality of components to the discrete measurements; determining, via the one or more processors, a dictionary matrix of a plurality of basis functions; applying the dictionary matrix of the plurality of basis functions to the model; determining a set of basis functions based on a minimization of a cost function; and determining, via the one or more processors, at least one component of the plurality of components based on the set of basis functions.

Embodiments of the present disclosure may also provide an apparatus including one or more processors, implemented at least in part in hardware; and a memory configured to store a set of instructions, executable by the one or more processors. The set of instructions perform operations including accessing, via one or more processors implemented at least in part in hardware, marine seismic data including a plurality of discrete measurements of a seismic wavefield; processing, via the one or more processors, the marine seismic data to determine a relationship between a plurality of components of the seismic wavefield and each of the discrete measurements; and estimating, via the one or more processors, from the marine seismic data processed via the one or more processors, each component of the seismic wavefield separated from each of the other plurality of components of the seismic wavefield and evaluated at a predetermined position.

Embodiments of the disclosure may also provide a non-transitory, computer-readable medium storing instructions that, when executed by at least one processor of a computing system, cause the computing system to perform operations. The operations include accessing, via one or more processors implemented at least in part in hardware, marine seismic data including a plurality of discrete measurements of a seismic wavefield; processing, via the one or more processors, the marine seismic data to determine a relationship between a plurality of components of the seismic wavefield and each of the discrete measurements; and estimating, via the one or more processors, from the marine seismic data processed via the one or more processors, each component of the seismic wavefield separated from each of the other plurality of components of the seismic wavefield and evaluated at a predetermined position.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIGS. 1A, 1B, 1C, 1D, 2, 3A, and 3B illustrate simplified, schematic views of an oilfield and its operation, according to an embodiment.

FIG. 4 illustrates a flowchart of a method for reducing uncertainties related to a ghost model in a process of joint interpolation and deghosting for marine seismic data processing, according to an embodiment.

FIG. 5 illustrates a flowchart of another method for reducing uncertainties related to a ghost model in a process of joint interpolation and deghosting for marine seismic data processing, according to an embodiment.

FIG. 6 illustrates a flowchart of another method for reducing uncertainties related to a process of joint interpolation and deghosting for marine seismic data processing, according to an embodiment.

FIG. 7 illustrates a flowchart of a method for reducing uncertainties related to a ghost model in a process of joint interpolation and deghosting for marine seismic data processing, according to an embodiment.

FIG. 8 illustrates a schematic view of a computing or processor system for performing the method, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both, objects or steps, respectively, but they are not to be considered the same object or step.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

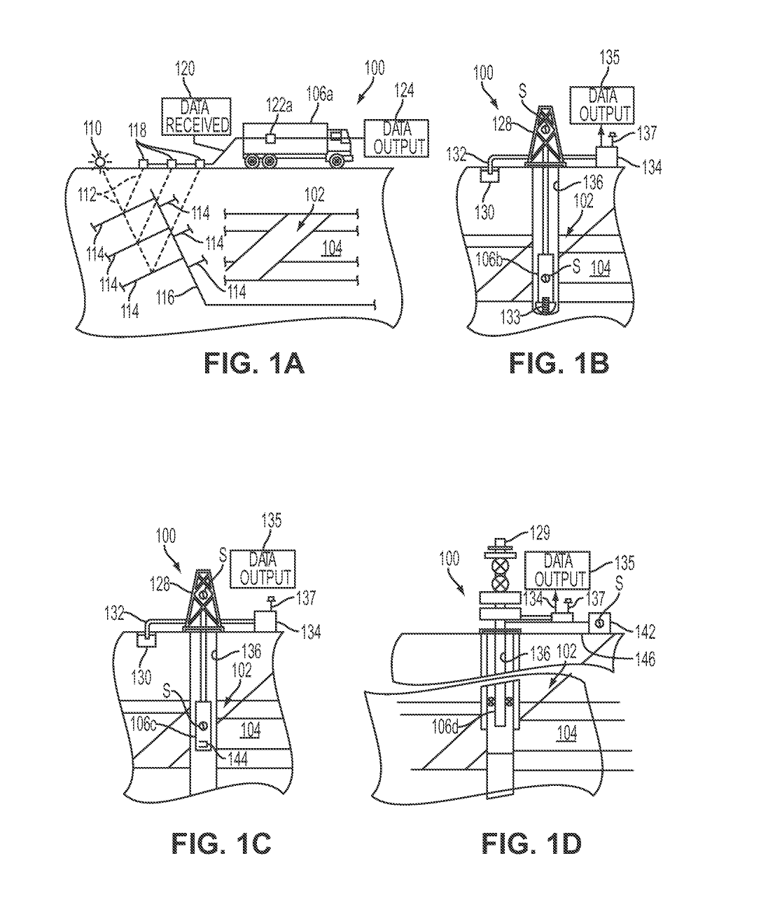

FIGS. 1A-1D illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106.1, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106.3 suspended by rig 128 and into wellbore 136 of FIG. 1B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

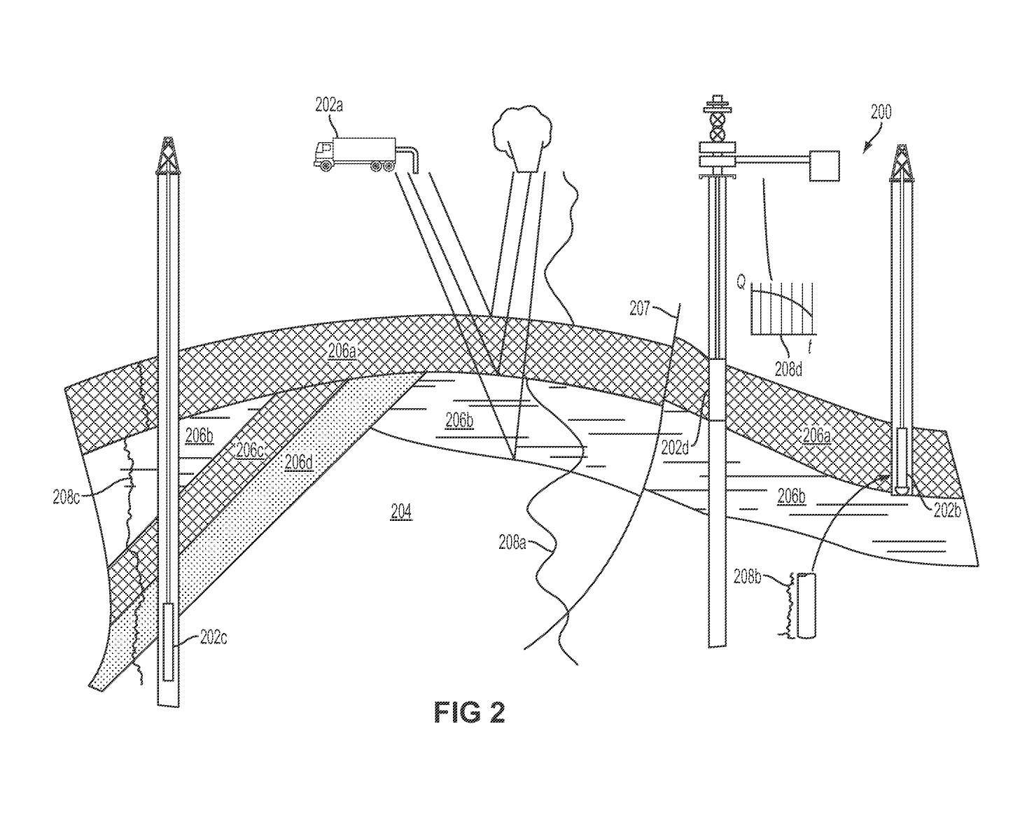

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1A-1D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

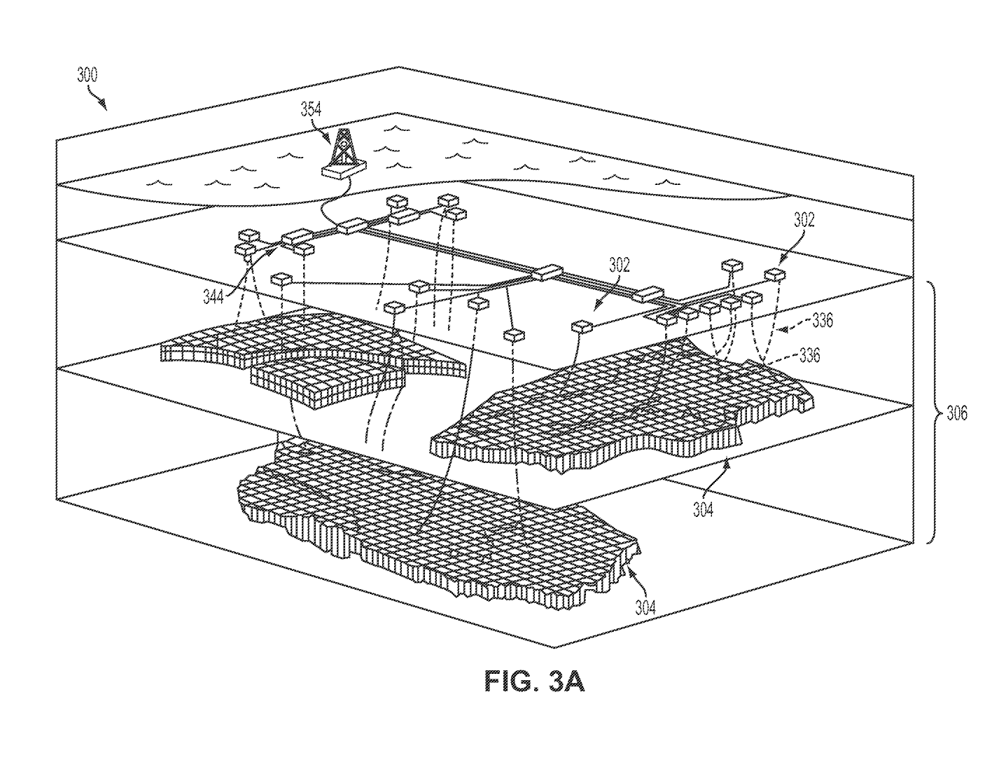

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. At least part of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Typically, marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

Embodiments of the present disclosure may include methods, computing systems, and non-transitory computer-readable media that overcome uncertainties related to the ghost model in the process of joint interpolation and deghosting for marine seismic data processing. As disclosed herein, joint interpolation and deghosting may be achieved without being driven by a ghost model. This may be accomplished using multi-sensor measurements including the pressure wavefield as well as particle motion vectors of the wavefield; however, these techniques may also be applied to pressure measurements, when multi-sensor seismic data is not available.

An approach to achieve joint interpolation and deghosting from the data may involve estimating the ghost model from the covariance matrix of the measured data, and then relying on that model to run in a similar manner to a ghost-model driven technique. In another embodiment, the measured data may be modelled as combination of the upgoing wavefield (e.g., propagating from the subsurface) and its downgoing replica (e.g., downward reflected by the free surface of the water), without making explicit the relationship between these two components, but treating them as if they were independent. From either of these approaches, a number of variations and different applications may be derived.

Assuming that the direct arrival has been removed from the measured data, the measured pressure data may be written as the combination of upgoing and downgoing wavefields as well as measured noise:

Pₙ=U+D+nₚ. (1)

The source may also be shooting at a greater depth than the measuring cable depth. In this expression, U represents the upgoing wavefield; D represents the downgoing wavefield; and nₚ represents the pressure noise. The combination of U+D may result in a constructive and destructive interference in different frequencies along the signal spectrum. This may create nulls or notches in the recorded spectrum reducing the effective bandwidth of the recorded seismic wavefield.

By analogy with Equation (1), the measured crossline V_{y}_{ₙ} and vertical particle velocity V_{z}_{ₙ} may be expressed as:

V_{y}_{ₙ}=jk_{y}(U+D)+n_{y} (2)

V_{z}_{ₙ}=jk_{z}(U−D)+n_{z} (3)

where k_{z} represents the vertical wavenumber and given by:

$${k}_{z} = \frac{2 π f}{c} cos θ = \sqrt{{( \frac{2 π f}{c} )}^{2} - {k}_{x}^{2} - {k}_{y}^{2}} , \qquad ( 4 )$$

and n_{z} is the scaled measured noise. The upgoing wave may be related to the downgoing wave as:

D=εe^{-j2zk}^{_{z}}U (5)

where ε is the reflection coefficient, z is the cable depth, and c is the acoustic speed of the seismic wave in water. As a result, Equations (1), (2) and (3) may be written as:

$$\begin{matrix}\begin{matrix}{P}_{n} = ( 1 + {ɛe}^{- k 2 {zk}_{z}} ) U + {n}_{p} \\ = {G}_{P} U + {n}_{p}\end{matrix} & ( 6 ) \\ \begin{matrix}{V}_{{y}_{n}} = \frac{{ck}_{y}}{f} ( 1 + {ɛe}^{- j 2 {zk}_{z}} ) U + {n}_{y} \\ = {G}_{y} U + {n}_{y}\end{matrix} & ( 7 ) \\ \begin{matrix}{V}_{{y}_{n}} = \frac{{ck}_{z}}{f} ( 1 - {ɛe}^{- j 2 {zk}_{z}} ) U + {n}_{z} \\ = {G}_{z} U + {n}_{z}\end{matrix} & ( 8 )\end{matrix}$$

where G_{P}, G_{y} and G_{z} are the ghost operators.

As disclosed herein, there may be one or more approaches to process the multi-sensor data to arrive at an estimate of the relationship between upgoing and downgoing wavefields, without making explicit use of a model that predicts a delay between the downgoing and upgoing wavefields based on geometrical considerations. One embodiment of such a method is a statistical based method that relies, at least in part, on the covariance matrix of the measured data, which implicitly describes the relationship between the actual measurements. In absence of noise and ideal geometry, the covariance matrix may correspond to the correlation of the ghost models.

In an embodiment, another method may be deterministic and may explain the data as a linear combination of upgoing and downgoing wavefields, and estimate both wavefields independently by processing the measured data. A less generic application of the second method models the downgoing wavefield as a delayed version of the upgoing wavefield, but it still does not relate the delay to any model of the propagation.

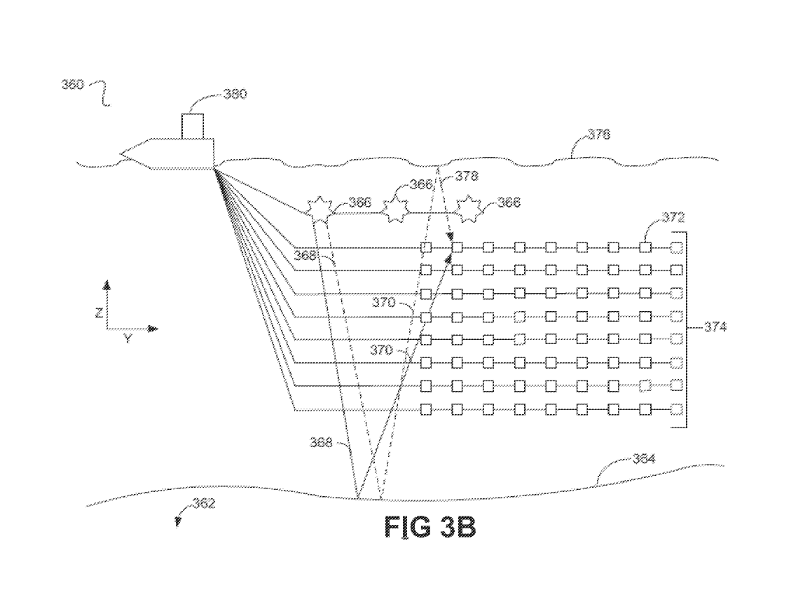

FIG. 4 illustrates a flowchart of a method 400 for reducing uncertainties related to a ghost model in a process of joint interpolation and deghosting for marine seismic data processing, according to an embodiment. The method 400 may include measuring data related to one or more subsurface wavefields with one or more sensors, as at 402. A ghost model may then be estimated from a covariance matrix of the measured data, as at 404.

The upgoing wavefield U may be estimated at any location optimally (e.g., in terms of output signal to noise ratio) by using the total pressure and particle motion measurements. The noise statistics for the pressure and vertical velocity may be assumed to be known or estimated from the data. This problem may be formulated in the frequency-space domain. However, it is noted that embodiments of the method 400 may be also implemented in other domains, such as the time-space domain, the time-wavenumber domain, or the frequency-wavenumber domain.

In some embodiments, without loss of generality, the pressure and the three components of the particle velocity measurements may be assumed to be zero mean. The proposed technique may be formulated as a Bayesian estimation scheme where the linear minimum mean square error estimator (l.m.m.s.e) may be obtained for the upgoing wavefield as a weighted sum of data d (e.g., pressure and particle velocity components). In particular, the upgoing wavefield may be estimated by applying a linear estimator, as set forth below:

$$\begin{matrix}\hat{U} ( {x}_{d} , {y}_{d} ) = & {\underline{w}}_{D}^{h} \underline{d} \\ = & {\sum }_{m = 1}^{M} {\sum }_{n = 1}^{N} {w}_{U , {P}_{mn}}^{*} {P}_{n} ( {x}_{m} , {y}_{n} ) + \\ & {\sum }_{m = 1}^{M} {\sum }_{n = 1}^{N} {w}_{U , {Y}_{mn}}^{*} {V}_{{y}_{n}} ( {x}_{m} , {y}_{n} ) + \\ & {\sum }_{m = 1}^{M} {\sum }_{n = 1}^{N} {w}_{U , {Z}_{mn}}^{*} {V}_{{z}_{n}} ( {x}_{m} , {y}_{n} )\end{matrix} \qquad ( 9 )$$

Similarly, the downgoing wave may be estimated by:

$$\begin{matrix}\hat{U} ( {x}_{d} , {y}_{d} ) = & {\underline{w}}_{D}^{h} \underline{d} \\ = & {\sum }_{m = 1}^{M} {\sum }_{n = 1}^{N} {w}_{D , {P}_{mn}}^{*} {P}_{n} ( {x}_{m} , {y}_{n} ) + \\ & {\sum }_{m = 1}^{M} {\sum }_{n = 1}^{N} {w}_{D , {Y}_{mn}}^{*} {V}_{{y}_{n}} ( {x}_{m} , {y}_{n} ) + \\ & {\sum }_{m = 1}^{M} {\sum }_{n = 1}^{N} {w}_{D , {Z}_{mn}}^{*} {V}_{{z}_{n}} ( {x}_{m} , {y}_{n} )\end{matrix} \qquad ( 10 )$$

where P(xₘ,yₙ) represents the acquired measurements of the total pressure wavefield (i.e., the measurements of the combined upgoing and downgoing wavefields); V_{y}_{ₙ}(xₘ,yₙ), V_{z}_{ₙ}(xₘ,yₙ) represent the crossline and vertical components of the particle motion data (e.g., the particle velocity data) acquired at non-uniformly spaced streamer positions; w_{U,P}_{ₘₙ}, w_{U,Y}_{ₘₙ} w_{U,Z}_{ₘₙ} w_{D,P}_{ₘₙ} w_{D,Y}_{ₘₙ} and w_{D,Z}_{ₘₙ} represent the interpolator coefficients to obtain the upgoing and the downgoing wavefields determined as described below; “*” represents the conjugation operation; and “M” represents the number of streamers.

In the least-squares-sense, an estimate of the upgoing pressure wavefield may be obtained by minimizing the variance of the reconstruction error, as set forth below:

$$\begin{matrix}W = arg {min}_{W} E \{ \vert \vert [ \begin{matrix}\hat{U} \\ \hat{D}\end{matrix} ] - [ \begin{matrix}U \\ D\end{matrix} ] {\vert \vert}^{2} \} \\ = arg {min}_{W} E \{ \vert \vert W \underline{d} - [ \begin{matrix}U \\ D\end{matrix} ] {\vert \vert}^{2} \} ,\end{matrix} \qquad ( 11 )$$

where E{•} is the expectation operator taken over the measurements and noise distributions. The weight matrix W is defined as:

$$W = [ \begin{matrix}{\underline{w}}_{U}^{H} \\ {\underline{w}}_{D}^{H}\end{matrix} ] \qquad ( 12 )$$

The minimizer of the cost function is called the linear minimum mean square error estimator. For the upgoing wave part, it may be expressed as the solution of the following set of normal equations:

$${R}_{dd} \underline{{w}_{U}} = {\underline{r}}_{dU} [ \begin{matrix}{R}_{{P}_{n} {P}_{n}} & {R}_{{P}_{n} {Y}_{n}} & {R}_{{P}_{n} {Z}_{n}} \\ {R}_{{P}_{n} {Y}_{n}}^{H} & {R}_{{Y}_{n} {Y}_{n}} & {R}_{{Y}_{n} {Z}_{n}} \\ {R}_{{P}_{n} {Z}_{n}}^{H} & {R}_{{Y}_{n} {Z}_{n}}^{H} & {R}_{{Z}_{n} {Z}_{n}}\end{matrix} ] [ \begin{matrix}{\underline{w}}_{P} \\ {\underline{w}}_{Y} \\ {\underline{w}}_{Z}\end{matrix} ] = [ \begin{matrix}{\underline{R}}_{PU} \\ {\underline{R}}_{YU} \\ {\underline{R}}_{ZU}\end{matrix} ] \qquad ( 13 )$$

where R_{dd}εC^{3MN×3MN}, R_{P}_{ₙ}_{P}_{ₙ}, R_{P}_{ₙ}_{V}_{ₙ}, R_{P}_{ₙ}_{Z}_{ₙ}, R_{Y}_{ₙ}_{Y}_{ₙ}, R_{Y}_{ₙ}_{Z}_{ₙ}, R_{Z}_{ₙ}_{Z}_{ₙ}εC^{MN×MN}, are correlations between the pressure and particle motion measurements. w is the total desired reconstruction weight, while wₚ, w_{y}, w_{z}εC^{MN×1} is the corresponding weight for pressure, crossline and vertical gradient measurements. r_{dU}εC^{3MN×1} and R_{PU}, R_{YU}, R_{ZU}εC^{MN×1} is the correlation vector between measurements and the unknown upgoing wave. A similar set of equations may be obtained for the downgoing wave. The correlation vector may be estimated adaptively from the data using the fact that upgoing wave may be obtained from averaging noise-free (or low-noise) pressure and vertical particle velocity scaled by the obliquity factor:

$$U = 0.5 ( P + \frac{c}{{fk}_{z}} {V}_{z} ) \qquad ( 14 )$$

In another embodiment, the correlation vector may be estimated adaptively from the data using the fact that upgoing wave may be obtained from averaging noise free and crossline particle velocity (e.g., scaled by the crossline wavenumber) and vertical particle velocity scaled by the obliquity factor:

$$U = \frac{0.5 c}{f} ( \frac{1}{{k}_{y}} {V}_{y} + \frac{1}{{k}_{z}} {V}_{z} ) \qquad ( 15 )$$

As a result, the correlation vector may be written as:

$$[ \begin{matrix}{\underline{R}}_{PU} \\ {\underline{R}}_{YU} \\ {\underline{R}}_{ZU}\end{matrix} ] = 0.5 ( α [ \begin{matrix}{R}_{PP} + \frac{c}{{fk}_{z}} {R}_{PZ} \\ {R}_{YP} + \frac{c}{{fk}_{z}} {R}_{YZ} \\ {R}_{ZP} + \frac{c}{{fk}_{z}} {R}_{ZZ}\end{matrix} ] + ( 1 - α ) \frac{c}{f} [ \begin{matrix}\frac{1}{{k}_{y}} {R}_{PY} + \frac{1}{{k}_{z}} {R}_{PZ} \\ \frac{1}{{k}_{y}} {R}_{YY} + \frac{1}{{k}_{z}} {R}_{YZ} \\ \frac{1}{{k}_{y}} {R}_{ZY} + \frac{1}{{k}_{z}} {R}_{ZZ}\end{matrix} ] ) \qquad ( 16 )$$

where 0≦α≦1 that can depend on the signal to noise ratio. R_{PP}, R_{YY}, R_{ZZ}, R_{PZ}, R_{PY}, R_{YZ} may be obtained from subtracting the noise statistics.

The correlation vector may be obtained in a similar way given that the downgoing wave may be obtained as:

$$\begin{matrix}D = 0.5 ( P - \frac{c}{{fk}_{z}} {V}_{z} ) \\ And & ( 17 ) \\ D = \frac{0.5 c}{f} ( \frac{1}{{k}_{y}} {V}_{y} - \frac{1}{{k}_{z}} {V}_{z} ) & ( 18 )\end{matrix}$$

The reconstruction error may be defined as:

$$C = [ \begin{matrix}{R}_{UU} & {R}_{UD} \\ {R}_{UD}^{H} & {R}_{DD}\end{matrix} ] - [ \begin{matrix}{\underline{r}}_{dU}^{H} \\ {\underline{r}}_{dD}^{H}\end{matrix} ] {R}_{dd}^{- 1} [ {\underline{r}}_{dU} {\underline{r}}_{dD} ] \qquad ( 19 )$$

This error may be used to iteratively solve Equations (9) and (13) for the upgoing wave components for different crossline wavenumbers. In other words, rather than solving for the upgoing waves simultaneously, each component may be solved for at a time similar to greedy search methods (e.g., matching pursuit). An example is shown below:

The technique may be initialized by setting:
Pᵣₑₛ=P
V=V_{y}
V_{y}_{ᵣₑₛ}=V_{y}
V_{z}_{ᵣₑₛ}=V_{z}

For different crossline wavenumbers, U and D may be estimated for different crossline wavenumbers. The crossline wavenumber [symbol] may be selected that minimizes C. The upgoing and downgoing components corresponding to this component may be subtracted using Equations (1), (2) and (3). This may be repeated until the convergence.

The measurement correlation may contain some information about the ghost operator. In fact, if the data is taken to a domain where a single upgoing wavefield is isolated (e.g., frequency wavenumber domain), the pressure ghost operator may be estimated from the correlations.

In another embodiment, the ghost operator or parameters (e.g., depth or reflection coefficient) may be estimated first from the correlations of the measurements and used in a ghost model based interpolation technique (e.g., Matching Pursuit).

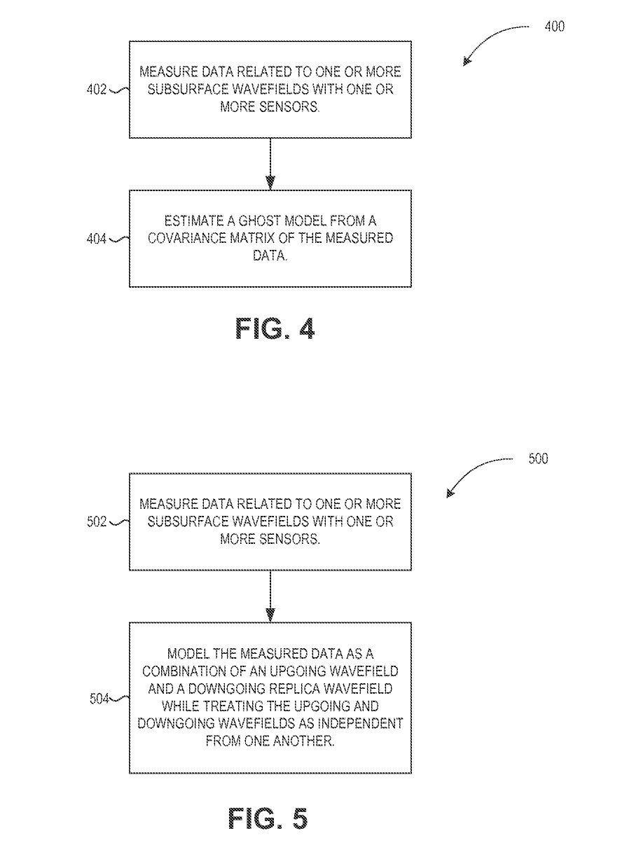

FIG. 5 illustrates a flowchart of a method 500 for reducing uncertainties related to a ghost model in a process of joint interpolation and deghosting for marine seismic data processing, according to an embodiment. The method 500 may include measuring data related to one or more subsurface wavefields with one or more sensors, as at 502. The method 500 may further include modelling the measured data as a combination of an upgoing wavefield and a downgoing replica wavefield while treating the upgoing and downgoing wavefields as independent from one another, as at 504.

The upgoing pressure wavefield may be assumed to be modelled for each given couple (f̅, k̅ₓ) at a specific cross-line locations y as a sum of complex exponentials, as follows:

U(f̅,k̅ₓ,y)=Σ_{iε}Aᵢexp(jk_{y,i}y), (20)

D(f̅,k̅ₓ,y)=Σ_{iε}Bᵢexp(jk_{y,i}y), (20)

where S is the set containing the amplitudes and wavenumbers. Aₙ is a complex quantity (amplitude and phase). Similar to Equations (1), (2) and (3), the pressure, crossline, and vertical particle velocity may be written as:

$$[ \begin{matrix}{p}_{n} \\ {V}_{{y}_{n}} \\ {V}_{{z}_{n}}\end{matrix} ] = [ \begin{matrix}1 & 1 \\ \frac{{ck}_{y}}{f} & \frac{{ck}_{y}}{f} \\ \frac{{ck}_{z}}{f} & - \frac{{ck}_{z}}{f}\end{matrix} ] [ \begin{matrix}U \\ D\end{matrix} ] + [ \begin{matrix}{n}_{P} \\ {n}_{Y} \\ {n}_{Z}\end{matrix} ] \qquad ( 22 )$$

Equation (22) may be written (e.g., omitting the noise) as the following set of equations

$$[ \begin{matrix}{P}_{1} \\ ⋮ \\ {P}_{M} \\ {V}_{{y}_{1}} \\ ⋮ \\ {V}_{{y}_{M}} \\ {V}_{{z}_{1}} \\ ⋮ \\ {V}_{{z}_{M}}\end{matrix} ] = [ \begin{matrix}exp ( {jk}_{y , 1} {y}_{1} ) & exp ( {jk}_{y , 1} {y}_{1} ) \\ ⋮ & ⋮ \\ exp ( {jk}_{y , 1} {y}_{M} ) & exp ( {jk}_{y , 1} {y}_{M} ) \\ \frac{{ck}_{y , 1}}{f} exp ( {jk}_{y , 1} {y}_{1} ) & \frac{{ck}_{y , 1}}{f} exp ( {jk}_{y , 1} {y}_{1} ) \\ ⋮ & ⋮ \\ \frac{{ck}_{y , 1}}{f} exp ( {jk}_{y , 1} {y}_{M} ) & \frac{{ck}_{y , 1}}{f} exp ( {jk}_{y , 1} {y}_{M} ) \\ \frac{{ck}_{z , 1}}{f} exp ( {jk}_{y , 1} {y}_{1} ) & - \frac{{ck}_{z , 1}}{f} exp ( {jk}_{y , 1} {y}_{1} ) \\ ⋮ & ⋮ \\ \frac{{ck}_{z , 1}}{f} exp ( {jk}_{y , 1} {y}_{M} ) & - \frac{{ck}_{z , 1}}{f} exp ( {jk}_{y , 1} {y}_{M} )\end{matrix} ] \cdot [ \begin{matrix}{A}_{1} \\ {B}_{1}\end{matrix} ] \qquad ( 23 )$$

Up to equation N

$$[ \begin{matrix}{P}_{1} \\ ⋮ \\ {P}_{M} \\ {V}_{{y}_{1}} \\ ⋮ \\ {V}_{{y}_{M}} \\ {V}_{{z}_{1}} \\ ⋮ \\ {V}_{{z}_{M}}\end{matrix} ] = [ \begin{matrix}exp ( {jk}_{y , N} {y}_{1} ) & exp ( {jk}_{y , N} {y}_{1} ) \\ ⋮ & ⋮ \\ exp ( {jk}_{y , N} {y}_{M} ) & exp ( {jk}_{y , N} {y}_{M} ) \\ \frac{{ck}_{y , N}}{f} exp ( {jk}_{y , N} {y}_{1} ) & \frac{{ck}_{y , N}}{f} exp ( {jk}_{y , N} {y}_{1} ) \\ ⋮ & ⋮ \\ \frac{{ck}_{y , N}}{f} exp ( {jk}_{y , N} {y}_{M} ) & \frac{{ck}_{y , N}}{f} exp ( {jk}_{y , N} {y}_{M} ) \\ \frac{{ck}_{z , N}}{f} exp ( {jk}_{y , N} {y}_{1} ) & - \frac{{ck}_{z , N}}{f} exp ( {jk}_{y , N} {y}_{1} ) \\ ⋮ & ⋮ \\ \frac{{ck}_{z , N}}{f} exp ( {jk}_{y , N} {y}_{M} ) & - \frac{{ck}_{z , N}}{f} exp ( {jk}_{y , N} {y}_{M} )\end{matrix} ] \cdot [ \begin{matrix}{A}_{N} \\ {B}_{N}\end{matrix} ] \qquad ( 24 )$$

In the previous set of equations, M is the number of measurements while N is the number of searched crossline wavenumbers. The solution of the systems described above may be performed in different ways. A direct solution may be achieved by inverting the matrix evaluating upgoing and downgoing wavefields at the desired positions. In another embodiment, a solution may be based on a matching pursuit approach, which may generalize the technique known as GMP. In yet another embodiment, one or more compressed sensing techniques may be used to determine the solution (e.g., minimizing the L1 norm of the error). In some cases, additional constraints may be added to this set of equations. For example, if the reflection coefficient is approximately 1, then:

|Aᵢ|≈|Bᵢ|

In another example, if the interpolation problem is solved, and deghosting occurs (e.g., multichannel interpolation using matching pursuit is performed in P and V_{y} measurements), then the constraint may be used as the total wavefield at interpolated positions that is

$$P ( {y}_{m} ) = {\sum }_{i} {A}_{i} exp ( {jk}_{y , N} {y}_{m} ) + {B}_{i} exp ( {jk}_{y , N} {y}_{m} )$$

Any linear combination of Equations (22) may instead be used. For example, rather than solving for the upgoing and downgoing waves simultaneously, the following set of equations may be used:

$$[ \begin{matrix}P + \frac{f}{{ck}_{z}} {V}_{z} \\ \frac{f}{c} ( {V}_{y} + \frac{{k}_{y}}{{k}_{z}} {V}_{z} )\end{matrix} ] = [ \begin{matrix}1 \\ {jk}_{y}\end{matrix} ] U \qquad ( 25 )$$

Similar to the previous set of equations, several ways to solve this set of equations may be used. Using matching pursuit, this set of equations is similar to MIMAP. The main difference is that, in this case, the measurement is also a function of the crossline wavenumber. In other words, in at least some iterations, instead of correlating a fixed measurement, a measurement vector that is function of the crossline wavenumber may be correlated.

In another embodiment, the second method may be realized with an Extended-Generalized Matching Pursuit approach by assuming the downgoing wavefield to be a delayed version of the upgoing wavefield, with unknown delay.

The measured data may be modelled as a linear combination of the upgoing and the downgoing wavefield. The upgoing wavefield may then be modelled as a sum of a set of parameteric basis functions, each representing a component of the upgoing wavefield, as a function of a number of unknown parameters. A delayed version of the each basis function, being the delay an additional unknown parameter, may represent the corresponding component of the downgoing wavefield.

Thus, a linear combination of each basis function and its delayed replica may be used to describe the contribution of the represented component of the wavefield to the actual measurements, as a function of a set of unknown parameter, including an unknown delay. The difference between the measured data and the modelled components calculated above may then be the input of a cost function, varying with the unknown parameters, including the unknown delay. The actual estimated upgoing and downgoing wavefields may then be estimated iteratively by minimizing the cost function and computing iteratively the optimal set of basis functions.

In accordance with another example, an approach to achieve joint interpolation and deghosting from the data may involve estimating the ghost model from the covariance matrix of the measured data, and then relying on that model to run in a similar manner to a ghost-model driven technique. In another embodiment, the measured data may be modelled as combination of the upgoing wavefield (e.g., propagating from the subsurface) and its downgoing replica (e.g., downward reflected by the free surface of the water), without making explicit the relationship between these two components, but treating them as if they were independent. From either of these approaches, a number of variations and different applications may be derived.

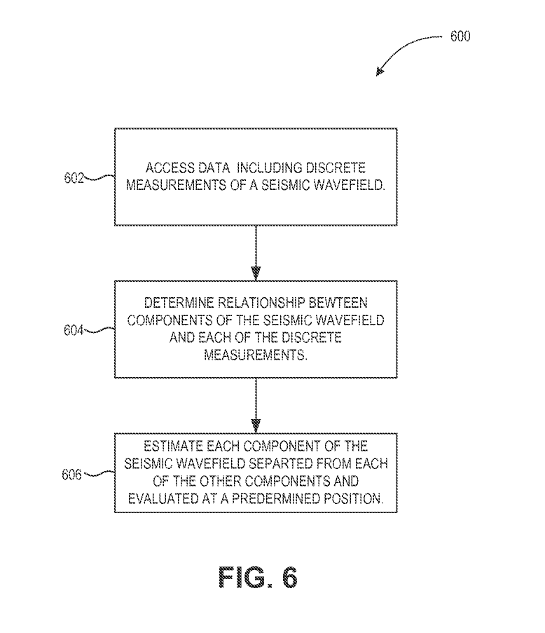

FIG. 6 illustrates a flowchart of a method 600 for reducing uncertainties related to a process of joint interpolation and deghosting for marine seismic data processing, according to an embodiment. The method 600 may include accessing, via one or more processors implemented at least in part in hardware, marine seismic data including a plurality of discrete measurements of a seismic wavefield at 602. The method may further include processing, via the one or more processors, the marine seismic data to determine a relationship between a plurality of components of the seismic wavefield and each of the discrete measurements at 604. The method may further include estimating, via the one or more processors, from the marine seismic data processed via the one or more processors, each component of the seismic wavefield separated from each of the other plurality of components of the seismic wavefield and evaluated at a predetermined position at 606.

The components of the seismic wavefield include an upgoing wavefield and a downgoing wavefield where the downgoing wavefield is a ghost reflection of the upgoing wavefield.

The plurality of discrete measurements include at least one of velocity, acceleration and particle motion measurements relating to a spatial gradient of pressure of the seismic wavefield.

The discrete measurements are subjected to spatial aliasing in one or more spatial dimensions.

As discussed above, processing the marine seismic data includes estimating a set of filter coefficients to predict the plurality of components of the seismic wavefield from the seismic measurements; determining, via the one or more processors, a covariance matrix of the discrete measurements based on the estimated set of filter coefficients; and determining, via the one or more processors, one of the plurality of components based on the covariance matrix of the marine seismic.

In other embodiments, processing the marine seismic data includes determining a model relating each of the plurality of components to the discrete measurements; determining, via the one or more processors, a dictionary matrix of a plurality of basis functions; applying the dictionary matrix of the plurality of basis functions to the model; determining a set of basis functions based on a minimization of a cost function; and determining, via the one or more processors, at least one component of the plurality of components based on the set of basis functions.

Assuming that the direct arrival has been removed from the measured data, the measured pressure data may be written as the combination of upgoing and downgoing wavefields as well as measured noise:

Pₙ=U+D+nₚ. (26)

The source may also be shooting at a greater depth than the measuring cable depth. In this expression, U represents the upgoing wavefield; D represents the downgoing wavefield; and nₚ represents the pressure noise. The combination of U+D may result in a constructive and destructive interference in different frequencies along the signal spectrum. This may create nulls or notches in the recorded spectrum reducing the effective bandwidth of the recorded seismic wavefield.

By analogy with Equation (26), the measured crossline V_{y}_{ₙ} and vertical particle velocity V_{z}_{ₙ} may be expressed as:

$$\begin{matrix}{V}_{{y}_{n}} = \frac{{ck}_{y}}{f} ( U + D ) + {n}_{y} & ( 27 ) \\ {V}_{{z}_{n}} = \frac{{ck}_{z}}{f} ( U - D ) + {n}_{z} & ( 28 )\end{matrix}$$

where n_{y},n_{z} is the scaled measured noise; c is the acoustic velocity of sound in water; f denotes frequency; kₓ, k_{y} and k_{z} represent the inline, crossline and vertical wavenumber respectively. The vertical wavenumber can be given by:

$${k}_{z} = \frac{f}{c} cos θ = \sqrt{{( \frac{f}{c} )}^{2} - {k}_{x}^{2} - {k}_{y}^{2} ,} \qquad ( 29 )$$

And n_{z} is the scaled measured noise. Note that the upgoing wave can be related to the downgoing wave as:

D=εe^{-j4zk}^{_{z}}U (30)

where ε is the reflection coefficient, z is the cable depth and c is the acoustic speed of seismic wave in water. As a result equations (26), (27) and (28) can be written as:

$$\begin{matrix}\begin{matrix}{P}_{n} = ( 1 + ɛ {e}^{- j 4 π {zk}_{z}} ) U + {n}_{p} \\ = {G}_{pU} + {n}_{p}\end{matrix} & ( 31 ) \\ \begin{matrix}{V}_{{y}_{n}} = \frac{{ck}_{y}}{f} ( 1 + ɛ {e}^{- j 4 π {zk}_{z}} ) U + {n}_{y} \\ = {G}_{y} U + {n}_{y}\end{matrix} & ( 32 ) \\ \begin{matrix}{V}_{{z}_{n}} = \frac{{ck}_{z}}{f} ( 1 - ɛ {e}^{- j 4 π {zk}_{z}} ) U + {n}_{z} \\ = {G}_{z} U + {n}_{z}\end{matrix} & ( 33 )\end{matrix}$$

where G_{P}, G_{y} and G_{Z} are the ghost operators. As can be seen from the previous equations, the particle motion data that are provided by the multi-sensor/multi-measurement are function of combination of the upgoing and downgoing wavefields. Therefore, the combination of pressure and particle motion data can be used to allow the recovery of “ghost” free data, which means data that are indicative of the upgoing wavefield. The Generalized Matching Pursuit GMP may rely on these ghost operators to achieve accurate interpolation and 3D deghosting. In other words, it assumes the perfect knowledge of the depth of the cable z and the reflection coefficient ε. Unfortunately, challenging conditions such as rough seas can cause some perturbations to these parameters. This may affect the quality of the reconstruction and deghosting by GMP.

As disclosed herein, there may be one or more approaches to process the multi-sensor data to arrive at an estimate of the relationship between upgoing and downgoing wavefields, without making explicit use of a model that predicts a delay between the downgoing and upgoing wavefields based on geometrical considerations. One embodiment of such a method is a statistical based method that relies, at least in part, on the covariance matrix of the measured data, which implicitly describes the relationship between the actual measurements. In absence of noise and ideal geometry, the covariance matrix may correspond to the correlation of the ghost models.

In an embodiment, another method may be deterministic and may explain the data as a linear combination of upgoing and downgoing wavefields, and estimate both wavefields independently by processing the measured data. A less generic application of the second method models the downgoing wavefield as a delayed version of the upgoing wavefield, but it still does not relate the delay to any model of the propagation.

The upgoing wavefield U may be estimated at any location (i.e., achieve joint reconstruction and 3D deghosting) optimally (in terms of output signal to noise ratio) by using the total pressure and particle motion measurements. The noise statistics for the pressure and vertical velocity are assumed to be known or estimated from the data. This problem may be formulated in the frequency space domain. However, it is noted that the proposed approach can be also implemented in other domains such as time-space, time-wavenumber or frequency-wavenumber.

In some embodiments, without loss of generality, the pressure and the three components of the particle velocity measurements may be assumed to be zero mean. A Bayesian estimation scheme may be employed where the linear minimum mean square error estimator (l.m.m.s.e) may be obtained for the upgoing wavefield as a weighted sum of data d (e.g., pressure and particle velocity components). In particular, the upgoing wavefield may be estimated by applying a linear estimator, as set forth below:

$$\begin{matrix}\hat{U} ( {x}_{d} , {y}_{d} ) = {\underline{w}}_{U}^{H} \underline{d} \\ = {\sum }_{m = 1}^{M} {\sum }_{n = 1}^{N} {w}_{U , {P}_{mn}}^{*} {P}_{n} ( {x}_{m} , {y}_{n} ) + \\ {\sum }_{m = 1}^{M} {\sum }_{n = 1}^{N} {w}_{U , {Y}_{mn}}^{*} {V}_{{y}_{n}} ( {x}_{m} , {y}_{n} ) + \\ {\sum }_{m = 1}^{M} {\sum }_{n = 1}^{N} {w}_{U , {Z}_{mn}}^{*} {V}_{{z}_{n}} ( {x}_{m} , {y}_{n} )\end{matrix} \qquad ( 34 )$$

Similarly, the downgoing wave us estimated by

$$\begin{matrix}\hat{D} ( {x}_{d} , {y}_{d} ) = {\underline{w}}_{D}^{H} \underline{d} \\ = {\sum }_{m = 1}^{M} {\sum }_{n = 1}^{N} {w}_{D , {P}_{mn}}^{*} {P}_{n} ( {x}_{m} , {y}_{n} ) + \\ {\sum }_{m = 1}^{M} {\sum }_{n = 1}^{N} {w}_{D , {Y}_{mn}}^{*} {V}_{{y}_{n}} ( {x}_{m} , {y}_{n} ) + \\ {\sum }_{m = 1}^{M} {\sum }_{n = 1}^{N} {w}_{D , {Z}_{mn}}^{*} {V}_{{z}_{n}} ( {x}_{m} , {y}_{n} )\end{matrix} \qquad ( 35 )$$

where P(xₘ,yₙ) represents the acquired measurements of the total pressure wavefield (i.e., the measurements of the combined upgoing and downgoing wavefields); V_{y}_{ₙ}(xₘ,yₙ), V_{z}_{ₙ}(xₘ,yₙ) represent the crossline and vertical components of the particle motion data (here, the particle velocity data) acquired at nonuniformly spaced streamer positions; w_{U,P}_{ₘₙ}, w_{U,Y}_{ₘₙ} w_{U,Z}_{ₘₙ} w_{D,P}_{ₘₙ} w_{D,Y}_{ₘₙ} and w_{D,Z}_{ₘₙ} represent the interpolator coefficients to obtain the upgoing and the downgoing determined as described below; “*” represents the conjugation operation; and “M” represents the number of streamers.

In the least-squares-sense, an estimate of the upgoing pressure wavefield may be obtained by minimizing the variance of the reconstruction error, as set forth below:

$$\begin{matrix}W = arg {min}_{W} E \{ {‖ [ \begin{matrix}\hat{U} \\ \hat{D}\end{matrix} ] - [ \begin{matrix}U \\ D\end{matrix} ] ‖}^{2} \} \\ = arg {min}_{W} E \{ {‖ W \underline{d} - [ \begin{matrix}U \\ D\end{matrix} ] ‖}^{2} \} ,\end{matrix} \qquad ( 36 )$$

where E{•} is the expectation operator taken over the measurements and noise distributions. The weight matrix W is defined as:

$$W = [ \begin{matrix}{\underline{w}}_{U}^{H} \\ {\underline{w}}_{D}^{H}\end{matrix} ] \qquad ( 37 )$$

The minimizer of the cost function is called the linear minimum mean square error estimator. For the upgoing wave part, it can be expressed as the solution of the following set of normal equation:

$$\begin{matrix}{R}_{dd} \underline{{w}_{U}} = {\underline{r}}_{dU} \\ [ \begin{matrix}{R}_{{P}_{n} {P}_{n}} & {R}_{{P}_{n} {Y}_{n}} & {R}_{{P}_{n} {Z}_{n}} \\ {R}_{{P}_{n} {Y}_{n}}^{H} & {R}_{{Y}_{n} {Y}_{n}} & {R}_{{Y}_{n} {Z}_{n}} \\ {R}_{{P}_{n} {Z}_{n}}^{H} & {R}_{{Y}_{n} {Z}_{n}}^{H} & {R}_{{Z}_{n} {Z}_{n}}\end{matrix} ] [ \begin{matrix}{\underline{w}}_{P} \\ {\underline{w}}_{Y} \\ {\underline{w}}_{Z}\end{matrix} ] = [ \begin{matrix}{\underline{R}}_{PU} \\ {\underline{R}}_{YU} \\ {\underline{R}}_{ZU}\end{matrix} ]\end{matrix} \qquad ( 38 )$$

where R_{dd}εC^{3MN×3MN}, R_{P}_{ₙ}_{P}_{ₙ}, R_{P}_{ₙ}_{V}_{ₙ}, R_{P}_{ₙ}_{Z}_{ₙ}, R_{Y}_{ₙ}_{Y}_{ₙ}, R_{Y}_{ₙ}_{Z}_{ₙ}, R_{Z}_{ₙ}_{Z}_{ₙ}εC^{MN×MN}, are correlations between the pressure and particle motion measurements. w is the total desired reconstruction weight, while wₚ, w_{y}, w_{z}εC^{MN×1} is the corresponding weight for pressure, crossline and vertical gradient measurements. r_{dU}εC^{3MN×1} and R_{PU}, R_{YU}, R_{ZU}εC^{MN×1} is the correlation vector between measurements and the unknown upgoing wave. A similar set of equations may be obtained for the downgoing wave. The correlation vector may be estimated adaptively from the data using the fact that upgoing wave may be obtained from averaging noise-free (or low-noise) pressure and vertical particle velocity scaled by the obliquity factor:

$$U = 0.5 ( P + \frac{f}{{ck}_{z}} {V}_{z} ) \qquad ( 39 )$$

In another embodiment, the correlation vector may be estimated adaptively from the data using the fact that upgoing wave may be obtained from averaging noise free and crossline particle velocity (e.g., scaled by the crossline wavenumber) and vertical particle velocity scaled by the obliquity factor:

$$U = 0.5 \frac{f}{c} ( \frac{1}{{k}_{y}} {V}_{y} + \frac{1}{{k}_{z}} {V}_{z} ) \qquad ( 40 )$$

As a result, the correlation vector may be written as:

$$[ \begin{matrix}{\underline{R}}_{PU} \\ {\underline{R}}_{YU} \\ {\underline{R}}_{ZU}\end{matrix} ] = 0.25 ( α [ \begin{matrix}{\underline{R}}_{PP} + \frac{f}{{ck}_{z}} {\underline{R}}_{PZ} \\ {\underline{R}}_{YP} + \frac{f}{{ck}_{z}} {\underline{R}}_{YZ} \\ {\underline{R}}_{ZP} + \frac{f}{{ck}_{z}} {\underline{R}}_{ZZ}\end{matrix} ] + ( 1 - α ) \frac{f}{c} [ \begin{matrix}\frac{1}{{k}_{y}} {\underline{R}}_{PY} + \frac{1}{{k}_{z}} {\underline{R}}_{PZ} \\ \frac{1}{{k}_{y}} {\underline{R}}_{YY} + \frac{1}{{k}_{z}} {\underline{R}}_{YZ} \\ \frac{1}{{k}_{y}} {\underline{R}}_{ZY} + \frac{1}{{k}_{z}} {\underline{R}}_{ZZ}\end{matrix} ] ) \qquad ( 41 )$$

where 0≦α≦1 that can depend on the signal to noise ratio. R_{PP}, R_{YY}, R_{ZZ}, R_{PZ}, R_{PY}, R_{YZ} may be obtained from subtracting the noise statistics.

The correlation vector may be obtained in a similar way given that the downgoing wave may be obtained as:

$$\begin{matrix}D = 0.5 ( P - \frac{f}{{ck}_{z}} {V}_{z} ) \\ And & ( 42 ) \\ D = 0.5 \frac{f}{c} ( \frac{1}{{k}_{y}} {V}_{y} - \frac{1}{{k}_{z}} {V}_{z} ) & ( 43 )\end{matrix}$$

As a result, the set of equations in (38) can be rewritten as:

$$[ \begin{matrix}{R}_{{P}_{n} {P}_{n}} & {R}_{{P}_{n} {Y}_{n}} & {R}_{{P}_{n} {Z}_{n}} \\ {R}_{{P}_{n} {Y}_{n}}^{H} & {R}_{{Y}_{n} {Y}_{n}} & {R}_{{Y}_{n} {Z}_{n}} \\ {R}_{{P}_{n} {Z}_{n}}^{H} & {R}_{{Y}_{n} {Z}_{n}}^{H} & {R}_{{Z}_{n} {Z}_{n}}\end{matrix} ] [ \begin{matrix}{\underline{W}}_{P} \\ {\underline{W}}_{Y} \\ {\underline{W}}_{Z}\end{matrix} ] = 0.25 ( α [ \begin{matrix}{\underline{R}}_{PP} + \frac{f}{{ck}_{z}} {\underline{R}}_{PZ} \\ {\underline{R}}_{YP} + \frac{f}{{ck}_{z}} {\underline{R}}_{YZ} \\ {\underline{R}}_{ZP} + \frac{f}{{ck}_{z}} {\underline{R}}_{ZZ}\end{matrix} ] + ( 1 - α ) \frac{f}{c} [ \begin{matrix}\frac{1}{{k}_{y}} {\underline{R}}_{PY} + \frac{1}{{k}_{z}} {\underline{R}}_{PZ} \\ \frac{1}{{k}_{y}} {\underline{R}}_{YY} + \frac{1}{{k}_{z}} {\underline{R}}_{YZ} \\ \frac{1}{{k}_{y}} {\underline{R}}_{ZY} + \frac{1}{{k}_{z}} {\underline{R}}_{ZZ}\end{matrix} ] ) \qquad ( 44 )$$

Note that in this equation, k_{y} is still unknown. To estimate k_{y}, any estimate of the upgoing wavefield that solves equation (19) will result in the following error energy:

$$C = [ \begin{matrix}{R}_{UU} & {R}_{UD} \\ {R}_{UD}^{H} & {R}_{DD}\end{matrix} ] - [ \begin{matrix}{\underline{r}}_{dU}^{H} \\ {\underline{r}}_{dD}^{H}\end{matrix} ] {R}_{dd}^{- 1} [ {\underline{r}}_{dU} {\underline{r}}_{dD} ] \qquad ( 45 )$$

This error may be used to iteratively solve Equations (34) and (44) for the upgoing wave components for different crossline wavenumber. In other words, rather than solving for the upgoing waves simultaneously, for each component may be solved at a time similar to greedy search methods (e.g., matching pursuit). An example is shown below:
The algorithm may be initialized by setting:
Pᵣₑₛ⁽⁰⁾=P
V_{y}_{ᵣₑₛ}⁽⁰⁾=V_{y}
V_{z}_{ᵣₑₛ}⁽⁰⁾=V_{z}
Û⁽⁰⁾=0
\hat{D}⁽⁰⁾=0

For different crossline wavenumbers, U and D may be estimated for different crossline wavenumbers. The crossline wavenumber [symbol] may be selected that minimizes C. Add the estimated upgoing and downgoing wave to the upgoing wave as

Û^{(k)}=Û^{(k-1)}+Û( [symbol] )

\hat{D}^{(k)}=\hat{D}^{(k-1)}+\hat{D}( [symbol] )

Subtract the upgoing and downgoing component corresponding to this component using equations (26), (27) and (28) and update Pᵣₑₛ^{(k)}, V_{y}_{ᵣₑₛ}^{(k)}, V_{z}_{ᵣₑₛ}^{(k)}
This may be repeated until the convergence.

In this example, different criteria can be used to stop the iterations. According to some embodiments, a possible criterion is to check if the total residual energy is minimum. According to other embodiments, a maximum number of iterations can also be used.

In other embodiments, the ghost operator or parameters (such as depth, reflection coefficient) can be estimated first from the correlations of the measurements and then used in a ghost model based interpolation technique (e.g., Generalized Matching Pursuit).

The upgoing pressure wavefield may be assumed to be modelled for every given couple (f̅,k̅ₓ) at a specific cross-line locations y as a sum of complex exponentials, as follows:

U(f̅,k̅ₓ,y)=Σ_{iεs}Aᵢ exp(j2πk_{y,i}y), (46)

D(f̅,k̅ₓ,y)=Σ_{iεs}Bᵢ exp(j2πk_{y,i}y), (47)

where S is the set containing the amplitudes and wavenumbers. Aₙ is a complex quantity (amplitude and phase). Similar to equations (26), (27) and (28), the pressure, crossline and vertical particle velocity for a single crossline wavenumber can be written as:

$$[ \begin{matrix}{P}_{n} \\ {V}_{{y}_{n}} \\ {V}_{{z}_{n}}\end{matrix} ] = [ \begin{matrix}1 & 1 \\ \frac{{ck}_{y}}{f} & \frac{{ck}_{y}}{f} \\ \frac{{ck}_{z}}{f} & - \frac{{ck}_{z}}{f}\end{matrix} ] [ \begin{matrix}U \\ D\end{matrix} ] + [ \begin{matrix}{n}_{P} \\ {n}_{Y} \\ {n}_{Z}\end{matrix} ] \qquad ( 48 )$$

If the set of crossline wavenumbers are discretised by k_{y,1}, . . . , k_{y,N} and accordingly, the set of their corresponding set of vertical wavenumbers k_{z,1}, . . . , k_{z,N}, the following set of equations can be used:

$$[ \begin{matrix}{P}_{1} \\ ⋮ \\ {P}_{M} \\ {V}_{{y}_{1}} \\ ⋮ \\ {V}_{{y}_{M}} \\ {V}_{{z}_{1}} \\ ⋮ \\ {V}_{{z}_{M}}\end{matrix} ] = [ \begin{matrix}exp ( j 2 π {k}_{y , 1} {y}_{1} ) & exp ( j 2 π {k}_{y , 1} {y}_{1} ) & ⋯ & exp ( j 2 π {k}_{y , N} {y}_{1} ) & exp ( j 2 π {k}_{y , N} {y}_{1} ) \\ ⋮ & ⋮ & ⋯ & ⋮ & ⋮ \\ exp ( j 2 π {k}_{y , 1} {y}_{M} ) & exp ( j 2 π {k}_{y , 1} {y}_{M} ) & ⋯ & exp ( j 2 π {k}_{y , N} {y}_{M} ) & exp ( j 2 π {k}_{y , N} {y}_{M} ) \\ \frac{{ck}_{y , 1}}{f} exp ( j 2 π {k}_{y , 1} {y}_{1} ) & \frac{{ck}_{y , 1}}{f} exp ( j 2 π {k}_{y , 1} {y}_{1} ) & ⋯ & exp ( \frac{{ck}_{y , 1}}{f} j 2 π {k}_{y , N} {y}_{1} ) & \frac{{ck}_{y , 1}}{f} exp ( j 2 π {k}_{y , N} {y}_{1} ) \\ ⋮ & ⋮ & ⋯ & ⋮ & ⋮ \\ \frac{{ck}_{y , 1}}{f} exp ( j 2 π {k}_{y , 1} {y}_{M} ) & \frac{{ck}_{y , 1}}{f} exp ( j 2 π {k}_{y , 1} {y}_{M} ) & ⋯ & \frac{{ck}_{y , 1}}{f} exp ( j 2 π {k}_{y , N} {y}_{M} ) & \frac{{ck}_{y , 1}}{f} exp ( j 2 π {k}_{y , N} {y}_{M} ) \\ \frac{{ck}_{z , 1}}{f} exp ( j 2 π {k}_{y , 1} {y}_{1} ) & \frac{{ck}_{z , 1}}{f} exp ( j 2 π {k}_{y , 1} {y}_{1} ) & ⋯ & \frac{{ck}_{z , 1}}{f} exp ( j 2 π {k}_{y , N} {y}_{1} ) & \frac{{ck}_{z , 1}}{f} exp ( j 2 π {k}_{y , N} {y}_{1} ) \\ ⋮ & ⋮ & ⋯ & ⋮ & ⋮ \\ \frac{{ck}_{z , 1}}{f} exp ( j 2 π {k}_{y , 1} {y}_{M} ) & \frac{{ck}_{z , 1}}{f} exp ( j 2 π {k}_{y , 1} {y}_{M} ) & ⋯ & \frac{{ck}_{z , 1}}{f} exp ( j 2 π {k}_{y , N} {y}_{M} ) & \frac{{ck}_{z , 1}}{f} exp ( j 2 π {k}_{y , N} {y}_{M} )\end{matrix} ] \qquad ( 49 )$$

In the previous set of equations, M is the number of measurements while N is the number of searched crossline wavenumbers. The previous equation is a linear system that can be written simply as:

y=Dx (50)

where y is the measurement vector

y=[P₁ . . . P_{M} V_{y}_{₁} . . . V_{y}_{_{M}} V_{z}_{₁} . . . V_{z}_{_{M}}]^{T}

D is known as the dictionary matrix and can be given by

$$D = [ \begin{matrix}exp ( j 2 π {k}_{y , 1} {y}_{1} ) & exp ( j 2 π {k}_{y , 1} {y}_{1} ) & ⋯ & exp ( j 2 π {k}_{y , N} {y}_{1} ) & exp ( j 2 π {k}_{y , N} {y}_{1} ) \\ ⋮ & ⋮ & ⋯ & ⋮ & ⋮ \\ exp ( j 2 π {k}_{y , 1} {y}_{M} ) & exp ( j 2 π {k}_{y , 1} {y}_{M} ) & ⋯ & exp ( j 2 π {k}_{y , N} {y}_{M} ) & exp ( j 2 π {k}_{y , N} {y}_{M} ) \\ \frac{{ck}_{y , 1}}{f} exp ( j 2 π {k}_{y , 1} {y}_{1} ) & \frac{{ck}_{y , 1}}{f} exp ( j 2 π {k}_{y , 1} {y}_{1} ) & ⋯ & exp ( \frac{{ck}_{y , 1}}{f} j 2 π {k}_{y , N} {y}_{1} ) & \frac{{ck}_{y , 1}}{f} exp ( j 2 π {k}_{y , N} {y}_{1} ) \\ ⋮ & ⋮ & ⋯ & ⋮ & ⋮ \\ \frac{{ck}_{y , 1}}{f} exp ( j 2 π {k}_{y , 1} {y}_{M} ) & \frac{{ck}_{y , 1}}{f} exp ( j 2 π {k}_{y , 1} {y}_{M} ) & ⋯ & \frac{{ck}_{y , 1}}{f} exp ( j 2 π {k}_{y , N} {y}_{M} ) & \frac{{ck}_{y , 1}}{f} exp ( j 2 π {k}_{y , N} {y}_{M} ) \\ \frac{{ck}_{z , 1}}{f} exp ( j 2 π {k}_{y , 1} {y}_{1} ) & \frac{{ck}_{z , 1}}{f} exp ( j 2 π {k}_{y , 1} {y}_{1} ) & ⋯ & \frac{{ck}_{z , 1}}{f} exp ( j 2 π {k}_{y , N} {y}_{1} ) & \frac{{ck}_{z , 1}}{f} exp ( j 2 π {k}_{y , N} {y}_{1} ) \\ ⋮ & ⋮ & ⋯ & ⋮ & ⋮ \\ \frac{{ck}_{z , 1}}{f} exp ( j 2 π {k}_{y , 1} {y}_{M} ) & \frac{{ck}_{z , 1}}{f} exp ( j 2 π {k}_{y , 1} {y}_{M} ) & ⋯ & \frac{{ck}_{z , 1}}{f} exp ( j 2 π {k}_{y , N} {y}_{M} ) & \frac{{ck}_{z , 1}}{f} exp ( j 2 π {k}_{y , N} {y}_{M} )\end{matrix} ]$$

and x is the spectrum vector

x=[A₁ B₁ A₂ B₂ . . . A_{N} B_{N}]^{T}

Note that x can viewed as a concatenation of 2×1 vectors (spectral block) as follows:

$$\underline{x} = {[ {A}_{1} {B}_{1}}_{\begin{matrix}⏟ \\ {\underline{x}}_{1}^{T}\end{matrix}} {{A}_{2} {B}_{2}}_{\begin{matrix}⏟ \\ {\underline{x}}_{2}^{T}\end{matrix}} ⋯ {{{A}_{N} {B}_{N} ]}^{T}}_{\begin{matrix}⏟ \\ {\underline{x}}_{N}^{T}\end{matrix}}$$

Where (•)^{T} denotes transpose. The matrix D can also be viewed accordingly as a concatenation of dictionary blocks small matrices as:

$$D = [ {D}_{1} {D}_{2} ⋯ {D}_{N} ]$$

$$Where$$

$${D}_{j} = [ \begin{matrix}exp ( j 2 π {k}_{y , j} {y}_{1} ) & exp ( j 2 π {k}_{y , i} {y}_{1} ) \\ ⋮ & ⋮ \\ exp ( j 2 π {k}_{y , j} {y}_{M} ) & exp ( j 2 π {k}_{y , j} {y}_{M} ) \\ \frac{{ck}_{y , j}}{f} exp ( j 2 π {k}_{y , j} {y}_{1} ) & \frac{{ck}_{y , j}}{f} exp ( j 2 π {k}_{y , j} , {y}_{1} ) \\ ⋮ & ⋮ \\ \frac{{ck}_{y , j}}{f} exp ( j 2 π {k}_{y , j} {y}_{M} ) & \frac{{ck}_{y , j}}{f} exp ( j 2 π {k}_{y , j} {y}_{M} ) \\ \frac{{ck}_{z , j}}{f} exp ( j 2 π {k}_{y , j} {y}_{1} ) & \frac{{ck}_{z , j}}{f} exp ( j 2 π {k}_{y , j} {y}_{1} ) \\ ⋮ & ⋮ \\ \frac{{ck}_{z , j}}{f} exp ( j 2 π {k}_{y , j} {y}_{M} ) & \frac{{ck}_{z , j}}{f} exp ( j 2 π {k}_{y , j} {y}_{M} )\end{matrix} ]$$

While the upgoing and downgoing wavefields in (46) and (47) is represented as a sum of complex exponentials, other basis functions can be used. If other basis functions are used, the matrix D in (49) and (50) can be modified accordingly.

The aim is to estimate the spectrum vector. The solution of the systems described in (50) can be performed in different ways. A direct solution could be simply achieved by inverting the matrix evaluating upgoing and downgoing wavefields at the desired positions if the number of measurements 3M≧N.

In equation (50), if the number of measurements is less than the number of potential cross-line wavenumbers, i.e., 3M<N, the system is underdetermined and additional assumptions are commonly used to solve such systems. For example, the model can be assumed to be sparse. However, in the standard sparsity model, the vector x can has few nonzero elements relative to its dimension. These elements can appear anywhere in the vector. However, in (50), the nonzero elements appear in blocks of 2 elements (i.e., A and B). So instead of the standard sparsity there is a block sparsity here.

According to some embodiments, one way to formulate this mathematically, the following may be defined:

∥•∥_{p,0}=Σₗ₌₁^{N}I(∥xₗ∥ₚ>0) 0<p<∞ (51)

With the indicator function I(•) and ∥•∥ₚ defining p-norm. Accordingly, the following optimization can be used

$$\underline{\hat{x}} = arg {min}_{\underline{x}} \vert \vert \underline{x} {\vert \vert}_{p , 0} s . t . \underline{y} \approx D \underline{x} \qquad ( 52 )$$

In other words, to estimate the cross-line wavenumbers and the complex amplitudes associated with the when the number of measurements is less than the number of possible wavenumbers, it is assumed that the vector x is block-sparse and a measure of sparsity is minimized as shown in (52). Note that according to other embodiments, other sparsity measures can be used instead (52) is a combinatorialy complex problem but under certain conditions, the solution can be computed using different techniques. One of these techniques will be described below and can be seen as a Matching Pursuit for p=2:

Initialize the residual r⁽⁰⁾=y and the estimated upgoing wave Û⁽⁰⁾(y)=0. At the k iteration: The index i^{(k)} of the dictionary block can be chosen that minimizes:

$${i}^{( k )} = {min}_{i} \vert \vert {\underline{r}}^{( k - 1 )} - {D}_{i} {\underline{x}}_{i} \vert \vert \qquad ( 53 )$$

The spectrum block xⱼ(k) that minimizes (53) may be obtained. In other words, the coefficients Aᵢ_{^{(k)}}, Bᵢ_{^{(k)}}
The estimated upgoing wavefield may be updated as:

Û^{(k)}(y)=Û^{(k-1)}(y)+Aᵢ_{^{(k)}} exp(j2πk_{y,i}_{^{(k)}}y) (54)

The residual may be updated as:

r^{(k)}=r^{(k-1)}−Dᵢ_{^{(k)}}xᵢ_{^{(k)}} (55)

The number of iterations k=k+1 may be updated.
The process may be repeated until convergence

According to other embodiments, assuming sparsity of the spectrum vector can be obtained by looking at the equation in (49) differently as follows:

$$\underline{y} = {Σ}_{i ∈ S} {D}_{i} {\underline{x}}_{i} + [ \begin{matrix}{n}_{P} \\ {n}_{Y} \\ {n}_{Z}\end{matrix} ] \qquad ( 56 )$$

And if x is block sparse enough, the sparsity measure that needs to be minimized can be formulated differently as:

$$\hat{\underline{x}} = {min}_{\underline{x}} \frac{1}{2} \vert \vert \underline{y} - {\sum }_{i = 1}^{N} {D}_{i} {\underline{x}}_{i} \vert \vert + λ {\sum }_{k = 1}^{N} \vert \vert {\underline{x}}_{k} {\vert \vert}_{2} \qquad ( 57 )$$

Where λ is a tuning parameter. Various Group Lasso type techniques can be used to solve equation (57).

Many other techniques may be used to solve a system of equation similar to equation (50), assuming some sort of block-sparsity measure in the spectrum vector (similar to equations (52) or (57) or variations of them) including: Model-Compressive Sampling Matched Pursuit, Block Orthogonal Matching Pursuit, and Group Basis Pursuit, etc.

In some cases, additional constraints can be added to this set of equations. Examples include:

If the reflection coefficient is approximately 1, then

|Aᵢ|≈|Bᵢ|

If the interpolation problem is solved, and deghosting is conducted (for example, multichannel interpolation interpolation using matching pursuit is performed in P and V_{y} measurements, then the constraint can be used as the total wavefield at interpolated positions, that is:

$$P ( {y}_{m} ) = {\sum }_{i} {A}_{i} exp ( {jk}_{y , N} {y}_{m} ) + {B}_{i} exp ( {jk}_{y , N} {y}_{m} )$$

Note that any linear combination of Equations (23) can be used instead. For example, rather than solving for the upgoing and downgoing simultaneously, the following set of equations are used:

$$[ \begin{matrix}( P + \frac{f}{{ck}_{z}} {V}_{z} ) \\ \frac{f}{c} ( {V}_{y} + \frac{{k}_{y}}{{k}_{z}} {V}_{z} )\end{matrix} ] = 2 [ \begin{matrix}1 \\ {k}_{y}\end{matrix} ] U \qquad ( 58 )$$

Similar to the previous set of equations, several ways to solve this set can be used. Using greedy methods, this set of equations is similar to MIMAP in (Vassallo et. al., 2010). The main difference is that in this case, the measurement is also a function of the crossline wavenumber. In other words, in every iteration instead of correlating fixed measurement, a measurement vector is correlated that is function of the crossline wavenumber.

In another embodiment, another method can be realized with an Extended-Generalized Matching Pursuit approach by assuming the downgoing wavefield to be a delayed version of the upgoing wavefield, with unknown delay.

The measured data would be modelled as a linear combination of the upgoing and the downgoing wavefield. The upgoing wavefield would then be modelled as a sum of a set of parameteric basis functions, each of them representing a component of the upgoing wavefield, as a function of a number of unknown parameters. A delayed version of the each basis function, being the delay an additional unknown parameter, would represent the corresponding component of the downgoing wavefield.

Hence, a linear combination of each basis function and its delayed replica would be used to describe the contribution of the represented component of the wavefield to the actual measurements, as a function of a set of unknown parameter, including an unknown delay.

The difference between the measured data and the modelled components calculated above would then be the input of a cost function, varying with the unknown parameters, including the unknown delay.

The actual estimated upgoing and downgoing wavefield would then be estimated iteratively by minimizing the cost function and computing iteratively the optimal set of basis functions.

The methods disclosed herein may represent a solution to a joint interpolation and deghosting problem. Multi-sensor seismic measurements may allow the reconstruction of the measured wavefield even in the presence of spatial aliasing. This may also apply to the methods described herein. In general, the methods disclosed provide a framework that may be used behind the joint interpolation and deghosting problem. In particular, the methods may be used to combine measurements that are not directly related by the ghost model. One possible application may be the multi-sensor interpolation when pressure and vertical particle motion component are available as the inputs. In other embodiments, any set of measurements that are related may be used as input to the methods disclosed herein.

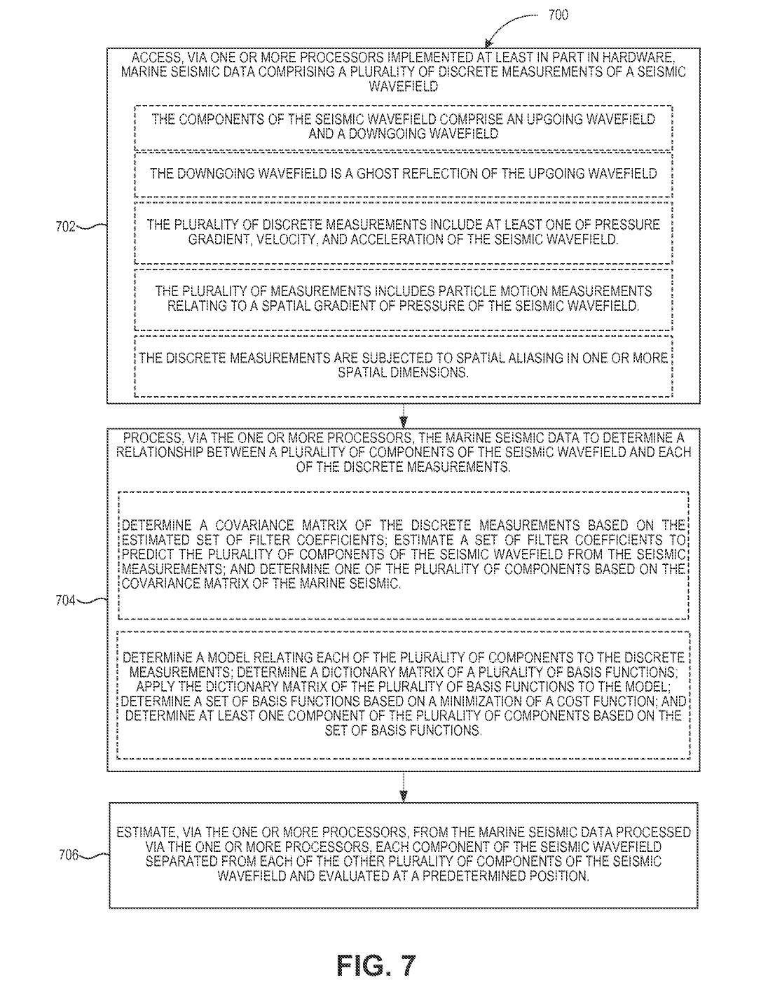

FIG. 7 illustrates a flowchart of a method 700 for reducing uncertainties related to a ghost model in a process of joint interpolation and deghosting for marine seismic data processing, according to an embodiment. The method 700 may include accessing, via one or more processors implemented at least in part in hardware, marine seismic data including a plurality of discrete measurements of a seismic wavefield at 702 (e.g., see FIG. 6, 602). In some embodiments, the components of the seismic wavefield include an upgoing wavefield and a downgoing wavefield. In some embodiments, the downgoing wavefield is a ghost reflection of the upgoing wavefield. In some embodiments, the plurality of discrete measurements include at least one of pressure gradient, velocity, and acceleration of the seismic wavefield.

In some embodiments, the plurality of measurements includes particle motion measurements relating to a spatial gradient of pressure of the seismic wavefield. In some embodiments, the discrete measurements are subjected to spatial aliasing in one or more spatial dimensions.

The method 700 may further include processing, via the one or more processors, the marine seismic data to determine a relationship between a plurality of components of the seismic wavefield and each of the discrete measurements at 704 (e.g., FIG. 6, 604).

In some embodiments, processing the marine seismic data includes determining, via the one or more processors, a covariance matrix of the discrete measurements based on the estimated set of filter coefficients; estimating a set of filter coefficients to predict the plurality of components of the seismic wavefield from the seismic measurements; and determining, via the one or more processors, one of the plurality of components based on the covariance matrix of the marine seismic.

In some embodiments, processing the marine seismic data includes determining a model relating each of the plurality of components to the discrete measurements; determining, via the one or more processors, a dictionary matrix of a plurality of basis functions; applying the dictionary matrix of the plurality of basis functions to the model; determining a set of basis functions based on a minimization of a cost function; and determining, via the one or more processors, at least one component of the plurality of components based on the set of basis functions.

The method of 700 may further include estimating, via the one or more processors, from the marine seismic data processed via the one or more processors, each component of the seismic wavefield separated from each of the other plurality of components of the seismic wavefield and evaluated at a predetermined position at 706 (e.g., FIG. 6, 606).

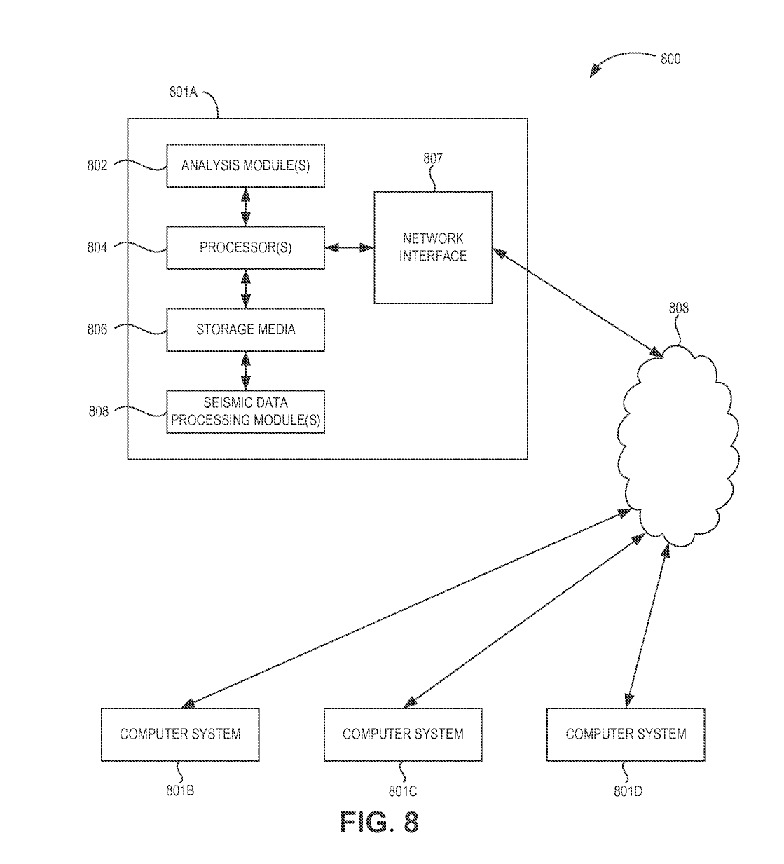

In some embodiments, the methods of the present disclosure may be executed by a computing system. FIG. 8 illustrates an example of such a computing system 800, in accordance with some embodiments. The computing system 800 may include a computer or computer system 801A, which may be an individual computer system 801A or an arrangement of distributed computer systems. The computer system 801A includes one or more analysis modules 802 that are configured to perform various tasks according to some embodiments, such as one or more methods disclosed herein. To perform these various tasks, the analysis module 802 executes independently, or in coordination with, one or more processors 804, which is (or are) connected to one or more storage media 806. The processor(s) 804 is (or are) also connected to a network interface 807 to allow the computer system 801A to communicate over a data network 808 with one or more additional computer systems and/or computing systems, such as 801B, 801C, and/or 801D (note that computer systems 801B, 801C and/or 801D may or may not share the same architecture as computer system 801A, and may be located in different physical locations, e.g., computer systems 801A and 801B may be located in a processing facility, while in communication with one or more computer systems such as 801C and/or 801D that are located in one or more data centers, and/or located in varying countries on different continents).

A processor can include a microprocessor, microcontroller, processor module or subsystem, programmable integrated circuit, programmable gate array, or another control or computing device.

The storage media 806 can be implemented as one or more non-transitory computer-readable or machine-readable storage media. Note that while in some example embodiments of FIG. 8 storage media 806 is depicted as within computer system 801A, in some embodiments, storage media 806 may be distributed within and/or across multiple internal and/or external enclosures of computing system 801A and/or additional computing systems. Storage media 806 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURRY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 800 contains one or more seismic data processing module(s) 808. In the example of computing system 800, computer system 801A includes the seismic data processing module 808. In some embodiments, a single seismic data processing module may be used to perform at least some aspects of one or more embodiments of the methods disclosed herein. In alternate embodiments, a plurality of seismic data processing modules may be used to perform at least some aspects of methods disclosed herein.

It should be appreciated that computing system 800 is merely one example of a computing system, and that computing system 800 may have more or fewer components than shown, may combine additional components not depicted in the example embodiment of FIG. 8, and/or computing system 800 may have a different configuration or arrangement of the components depicted in FIG. 8. The various components shown in FIG. 8 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of protection of the invention.

Geologic interpretations, models and/or other interpretation aids may be refined in an iterative fashion; this concept is applicable to methods as discussed herein. This can include use of feedback loops executed on an algorithmic basis, such as at a computing device (e.g., computing system 800, FIG. 8), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principals of the invention and its practical applications, to thereby enable others skilled in the art to best utilize the invention and various embodiments with various modifications as are suited to the particular use contemplated.

What is claimed is:

1. A computer-implemented method, comprising:
accessing, via one or more processors implemented at least in part in hardware, marine seismic data comprising a plurality of discrete measurements of a seismic wavefield;
processing, via the one or more processors, the marine seismic data to determine a relationship between a plurality of components of the seismic wavefield and each of the discrete measurements; and
estimating, via the one or more processors, from the marine seismic data processed via the one or more processors, each component of the seismic wavefield separated from each of the other plurality of components of the seismic wavefield and evaluated at a predetermined position.

2. The computer-implemented method of claim 1, wherein the components of the seismic wavefield comprise an upgoing wavefield and a downgoing wavefield.

3. The computer-implemented method of claim 2, wherein the downgoing wavefield is a ghost reflection of the upgoing wavefield.

4. The computer-implemented method of claim 1, wherein the plurality of discrete measurements include at least one of pressure gradient, velocity, and acceleration of the seismic wavefield.

5. The computer-implemented method of claim 1, wherein the plurality of measurements includes particle motion measurements relating to a spatial gradient of pressure of the seismic wavefield.

6. The computer-implemented method of claim 1, wherein the discrete measurements are subjected to spatial aliasing in one or more spatial dimensions.

7. The computer-implemented method of claim 1, wherein processing the marine seismic data comprises:
determining, via the one or more processors, a covariance matrix of the discrete measurements based on the estimated set of filter coefficients;
estimating a set of filter coefficients to predict the plurality of components of the seismic wavefield from the seismic measurements; and
determining, via the one or more processors, one of the plurality of components based on the covariance matrix of the marine seismic.

8. The computer-implemented method of claim 1, wherein processing the marine seismic data comprises:
determining a model relating each of the plurality of components to the discrete measurements;
determining, via the one or more processors, a dictionary matrix of a plurality of basis functions;
applying the dictionary matrix of the plurality of basis functions to the model;
determining a set of basis functions based on a minimization of a cost function; and
determining, via the one or more processors, at least one component of the plurality of components based on the set of basis functions.

9. An apparatus, comprising:
one or more processors, implemented at least in part in hardware;
a memory configured to store a set of instructions, executable by the one or more processors, the set of instructions comprising:
accessing, via one or more processors implemented at least in part in hardware, marine seismic data comprising a plurality of discrete measurements of a seismic wavefield;
processing, via the one or more processors, the marine seismic data to determine a relationship between a plurality of components of the seismic wavefield and each of the discrete measurements; and
estimating, via the one or more processors, from the marine seismic data processed via the one or more processors, each component of the seismic wavefield separated from each of the other plurality of components of the seismic wavefield and evaluated at a predetermined position.

10. The apparatus of claim 9, wherein the components of the seismic wavefield comprise an upgoing wavefield and a downgoing wavefield.

11. The apparatus of claim 10, wherein the downgoing wavefield is a ghost reflection of the upgoing wavefield.

12. The apparatus of claim 9, wherein the plurality of discrete measurements include at least one of pressure gradient, velocity, and acceleration of the seismic wavefield.

13. The apparatus of claim 9, wherein the plurality of measurements includes particle motion measurements relating to a spatial gradient of pressure of the seismic wavefield.

14. The apparatus of claim 9, wherein the discrete measurements are subjected to spatial aliasing in one or more spatial dimensions.

15. The apparatus of claim 9, wherein processing the marine seismic data comprises:
determining, via the one or more processors, a covariance matrix of the discrete measurements based on the estimated set of filter coefficients;
estimating a set of filter coefficients to predict the plurality of components of the seismic wavefield from the seismic measurements; and
determining, via the one or more processors, one of the plurality of components based on the covariance matrix of the marine seismic.

16. The apparatus of claim 9, wherein processing the marine seismic data comprises:
determining a model relating each of the plurality of components to the discrete measurements;
determining, via the one or more processors, a dictionary matrix of a plurality of basis functions;
applying the dictionary matrix of the plurality of basis functions to the model;
determining a set of basis functions based on a minimization of a cost function; and
determining, via the one or more processors, at least one component of the plurality of components based on the set of basis functions.

17. A non-transitory computer-readable medium storing instructions that, when executed by at least one processor of a computing system, cause the computing system to perform operations, the operations comprising:
accessing, via one or more processors implemented at least in part in hardware, marine seismic data comprising a plurality of discrete measurements of a seismic wavefield;
processing, via the one or more processors, the marine seismic data to determine a relationship between a plurality of components of the seismic wavefield and each of the discrete measurements; and
estimating, via the one or more processors, from the marine seismic data processed via the one or more processors, each component of the seismic wavefield separated from each of the other plurality of components of the seismic wavefield and evaluated at a predetermined position.

18. The non-transitory computer-readable medium of claim 17, wherein processing the marine seismic data comprises:
determining, via the one or more processors, a covariance matrix of the discrete measurements based on the estimated set of filter coefficients;
estimating a set of filter coefficients to predict the plurality of components of the seismic wavefield from the seismic measurements; and
determining, via the one or more processors, one of the plurality of components based on the covariance matrix of the marine seismic.

19. The non-transitory computer-readable medium of claim 17, wherein processing the marine seismic data comprises:
determining a model relating each of the plurality of components to the discrete measurements;
determining, via the one or more processors, a dictionary matrix of a plurality of basis functions;
applying the dictionary matrix of the plurality of basis functions to the model;
determining a set of basis functions based on a minimization of a cost function; and
determining, via the one or more processors, at least one component of the plurality of components based on the set of basis functions.

20. The non-transitory computer-readable medium of claim 17, wherein the components of the seismic wavefield comprise an upgoing wavefield and a downgoing, the downgoing wavefield being a ghost reflection of the upgoing wavefield, and wherein the plurality of discrete measurements include at least one of velocity, acceleration, and particle motion measurements relating to a spatial gradient of pressure of the seismic wavefield.
